(19) United States
(12) Patent Application Publication
(10) Pub. No.: US 2007/0261405 A1
(43) Pub. Date: Nov. 15, 2007

(54) Hydraulic system

(75) Inventor: Markus Hausner, Karlsruhe (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LUK LAMELLEN UND KUPPLUNGSBAU BETEILIGUNGS KG, Buehl (DE)

(21) Appl. No.: 11/796,448

(22) Filed: Apr. 27, 2007

(30) Foreign Application Priority Data
Apr. 29, 2006 (DE) 102006019975.8

(51) Int. Cl. B60T 11/20

(52) U.S. Cl. 60/562

(57) ABSTRACT

A hydraulic system, in particular for motor vehicles, including a master cylinder having a housing and a ring piston that is axially displaceable in it and is sealed against this housing, and a pressure medium outlet, as well as a slave cylinder having a housing and a ring piston that is axially displaceable in it and is sealed against this housing, and a pressure medium inlet, as well as a pressure medium line that connects the pressure medium inlet and the pressure medium outlet in a hydraulically effective way, where these parts and their components have specific individual rigidities; this total rigidity or base rigidity C₀ of the hydraulic system is increased through the use of pistons for master cylinders having an area of 300 mm²-1000 mm² and through the use of ring pistons for a slave cylinder having an area of 800 mm²-2500 mm².

This claims the benefit of German Patent Application No. 10 2006 019 975.8, filed on Apr. 29, 2006 and hereby incorporated by reference herein.

The invention relates to a hydraulic system, in particular for motor vehicles, including a master cylinder including at least a housing having a piston that is axially displaceable in it and is sealed against this housing and a pressure medium outlet, as well as a slave cylinder consisting of at least a housing having a piston that is axially displaceable in it and is sealed against this housing and a pressure medium inlet, as well as a pressure medium line that connects the pressure medium inlet and the pressure medium outlet in a hydraulically effective way, as well as a pressure medium for filling the hydraulic system.

### BACKGROUND

Such hydraulic systems are employed in particular in motor vehicles as devices for operating friction clutches, for example in the power flow between a combustion engine and a transmission and/or an electric motor and a drive train. In these cases, as a rule a linear motion is transmitted via a hydraulic cylinder by the driver or an automatically selected actuator system depending on the driving situation, through a transmission of the pressure produced in the master cylinder by means of the master cylinder piston in the line which joins the pressure and slave cylinders, filled with pressure means or pressure medium, to the slave cylinder, which performs the desired effect, for example operation of a clutch or the like, through a linear motion of the slave cylinder piston induced by the pressure, with respect to the stationary-mounted slave cylinder housing. Such a hydraulic system is also referred to as a hydraulic disengaging system.

Hydraulic disengaging systems may be hydrostatic systems, as in the present case, in which the volume of oil needed for example for a clutch disengagement process remains constant in the closed system. To keep the oil volume constant in the hydraulic path, in which slight leakage losses occur for example due to expansions in the connecting lines or to points of leakage, this slight volume of loss is equalized by means of an expansion tank. The transmission of an introduced force (pedal or motor power) from an activating element (pedal) or activating device to the clutch occurs substantially via the corresponding pressure areas of the pistons of the master and slave cylinder in the hydraulic system. Two different types of slave cylinders are used. In one case it may be a slave cylinder which is arranged concentrically around the transmission input shaft (concentric slave cylinder, abbreviated CSC), and which exerts a disengaging force on the clutch from this position; in the other case it may be a slave cylinder which transmits the disengaging force to the clutch through a lever mechanism.

The total rigidity of a hydraulic disengaging system is made up of the various individual rigidities of the components present in the hydraulic path, with the rigidity being defined as a value that describes the connection between a load that acts on a body and the resulting deformation of the latter. The rigidity of a body or component depends on its material as well as its geometry. In relation to this statement, it is essentially the design of the piston area for master and slave cylinders for example for CSCs that ultimately determines the overall stiffness of the system. The individual rigidities also represent sources of loss for the pressure to be transmitted from a pedal and the length of the disengagement travel to apply force for example to a clutch. With the pistons used as standard today in the passenger car field and their pressure areas (198 mm² or 285 mm² for master cylinders, 585 mm² to 775 mm² for CSCs, and 360-400 mm² for slave cylinders) a rigidity C₀ results, which is also referred to as the base rigidity. In addition, this base rigidity is influenced by the materials used for the individual components in the hydraulic path. For reasons of cost, the dimensions mentioned for the piston areas that are employed at present in clutch operating systems are based on the standard sizes for piston areas for brake systems. Up to now, the construction space circumstances in the engine compartment have also permitted the use of these standard sizes in clutch operating systems. However, the rigidity C₀ of the entire hydraulic system attainable with these standardized piston areas does not permit reduction of expansions resulting for example from pressure or temperature increases in the hydraulic path, which however acts very disadvantageously on the length of the power transmission path and the force itself that must be provided.

To reduce the expansions in the hydraulic path, the total rigidity of the system must be increased, which could be accomplished for example through the use of materials with greater rigidity for the individual components or by increasing the respective wall thicknesses. However, optimizing the rigidity of the master or slave cylinder results in increasing the pressure in the hydraulic path, which in turn has a detrimental effect on the life of the latter.

### SUMMARY OF THE INVENTION

An object of the invention is to reduce the losses in the hydraulic path for clutch operation by increasing the rigidity of the overall system, while the pressure conditions that arise during operation of the clutch should be reduced or at least kept the same.

The present invention provides a hydraulic system, in particular for motor vehicles, including a master cylinder having a housing and a piston that is axially displaceable in it and is sealed against this housing, which piston has a specific individual rigidity, and a pressure medium outlet, as well as a slave cylinder which may be designed as a ring-shaped slave cylinder arranged concentrically around the transmission input shaft (concentric slave cylinder, CSC), having a housing and a piston that is axially displaceable in it and is sealed against this housing, which piston also has a specific individual rigidity, and a pressure medium inlet as well as a pressure medium line that connects the pressure medium inlet and the pressure medium outlet in a hydraulically effective way, these components each having specific individual rigidities whose sum defines a total rigidity of the hydraulic system, this total rigidity can be increased through the use of pistons for master cylinders having an area of 300 mm²-1000 mm² and through the use of pistons for a CSC having an area of 800 mm²-2500 mm².

A preferred embodiment of the invention provides for increasing the total rigidity of the disengagement system through the use of pistons for master cylinders having an area of 350 mm²-500 mm² and through the use of pistons for a CSC having an area of 1000 mm²-1500 mm².

Based on the above observations in the existing art, it is surprisingly found that an increase in the total rigidity of the disengagement system can be attained by enlarging the piston areas. A slight rigidity would be expected, since under the same pressure increase on the housing due to the large piston areas cannot be avoided. It has turned out during implementation of this solution, however, that through the enlargement of the piston and hence the pressure areas of the master and slave cylinders compared to present-day systems and with the same pressure level, that the volumes of loss does in fact increase at first while the rigidities of the components are reduced in relation to the pressure. At the same time, the system pressure can also be reduced, whereby the rigidity of the overall system is again increased.

It can be seen from this that a proportional connection exists between the enlargement of the piston areas and the total rigidity of the disengaging system.

The present invention also provides a hydraulic system, in particular for motor vehicles, including a master cylinder having a housing and a ring piston that is axially displaceable in it and is sealed against this housing, as well as a slave cylinder, which may be designed as a ring-shaped slave cylinder arranged concentrically around the transmission input shaft (concentric slave cylinder, CSC), having a housing and a piston that is axially displaceable in it and is sealed against this housing, and a pressure medium inlet as well as a pressure medium line that connects the pressure medium inlet and the pressure medium outlet in a hydraulically effective way, whereby a force for disengaging a clutch introduced by an actuator, for example a pedal, is transmitted, where the transmission losses in the hydraulic path are reduced when using pistons for master cylinders having an area of 350 mm²-500 mm², preferably of 300 mm²-1000 mm², and through the use of ring pistons for the slave cylinder having an area of 1000 mm²-1500 mm², preferably of 800 mm²-2500 mm², whereby the disengagement force is also reduced.

Of particular advantage is the fact that the disengaging reserve is increased through the enlargement of the piston areas. The disengaging reserve means the travel distance covered by the master cylinder piston from a force-free zero position to the first reaction of the clutch.

The present invention further provides a hydraulic system, in particular for motor vehicles, including a master cylinder having a housing and a piston that is axially displaceable in it and is sealed against this housing, as well as a slave cylinder, which may be designed as a ring-shaped slave cylinder arranged concentrically around the transmission input shaft (concentric slave cylinder, CSC), having a housing and a piston that is axially displaceable in it and is sealed against this housing, and a pressure medium inlet as well as a pressure medium line that connects the pressure medium inlet and the pressure medium outlet in a hydraulically effective way, whereby a force for disengaging a clutch introduced by an actuator, for example a pedal, is transmitted, where the transmission ratio in the disengaging system is changed through the use of pistons for master cylinders having an area of 350 mm²-500 mm², preferably of 300 mm²-1000 mm², and through the use of pistons for a CSC having an area of 1000 mm²-1500 mm², preferably of 800 mm²-2500 mm², whereby the pedal force can be reduced by 7%, preferably by 8%.

### BRIEF DESCRIPTION OF THE DRAWINGS

The invention will now be explained in greater detail on the basis of an exemplary embodiment.

The figures show the following:

FIG. 1: a schematic depiction of a disengagement system using an exemplary embodiment of a clutch disengaging device,

FIG. 2a: Individual losses based on a slave cylinder (CSC) arranged concentrically around the transmission input shaft, in sectional view,

FIG. 2b: Individual losses based on a CSC in perspective view,

FIG. 3a: Individual losses based on a semi-hydraulic disengagement system, where the master cylinder is portrayed in sectional view,

FIG. 3b: Individual losses based on a semi-hydraulic disengagement system, where the master cylinder is portrayed in perspective view,

FIG. 4: A clarification of the individual losses with a hydraulic disengagement system according to the existing art,

FIGS. 5, 6, 7, 8 and 9: The loss reduction using the solution according to the invention in the hydraulic disengagement system.

### DETAILED DESCRIPTION

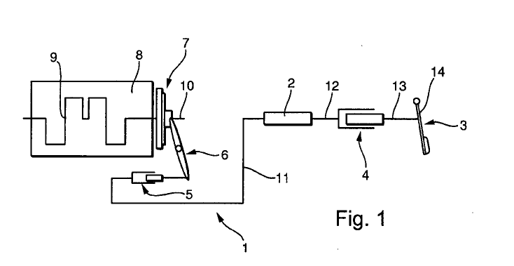

FIG. 1 shows a schematic depiction of a possible design of a hydraulic system 1 with a pressure limiting valve 2, based on a clutch disengaging device 3 having a master cylinder 4 and a slave cylinder 5. In the exemplary embodiment shown, the pressure limiting valve 2 is installed between runs 11 and 12 of the line. It is understood that in other exemplary embodiments the pressure limiting valve 2 can be integrated into either the master cylinder 4 or the slave cylinder 5.

The clutch disengaging system 3 operates the clutch 7 hydraulically by impinging on the master cylinder 4 by means of a control element 14, which may be a foot pedal, an actuator, for example an electrical actuator, or the like. Using a mechanical transmission 13 this causes pressure to be built up in the master cylinder 4, which builds up a pressure in the slave cylinder 5 through line run 12, through the pressure limiting valve 2 and line run 11. The slave cylinder 5 can be arranged concentrically around the transmission input shaft 10 (CSC), contrary to the embodiment shown in FIG. 1, and may be braced axially on a transmission housing and apply the necessary disengagement force through a throw-out bearing to the clutch 7 or its disengagement elements, such as diaphragm springs. Pressure is applied axially to the disengaging mechanism 6 using a piston which in hydraulically connected to master cylinder 4 and contained in the slave cylinder housing. To apply the disengaging force, slave cylinder 5 is attached with its housing fixed to the transmission housing or to some other component with a fixed housing. When clutch 7 is engaged, the transmission input shaft transmits the torque of the combustion engine 8 to a transmission and then to the drive wheels of a motor vehicle.

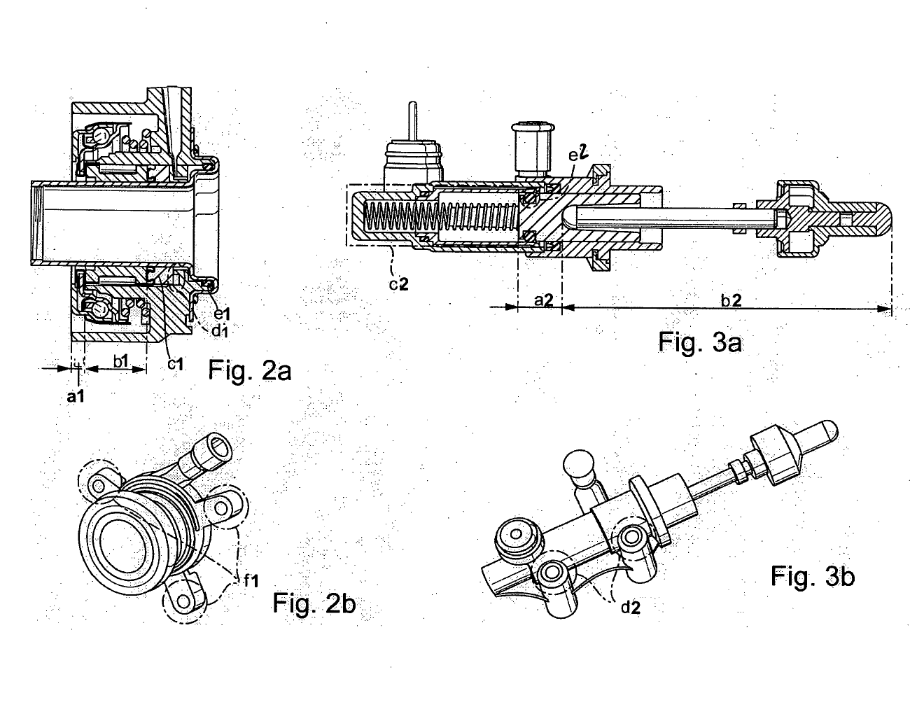

FIGS. 2a through 3b show schematically the requisite components in the hydraulic path for operating the clutch. The locations on the parts are highlighted which influence the total rigidity of this hydraulic system due to the construction elements used at those locations with their respective specific individual rigidities. FIG. 2a shows a slave cylinder designed as a CSC, which includes a housing that has a cutout for penetration by a transmission input shaft, whose size is defined by a guide sleeve connected to this housing. Positioned between this guide sleeve and the housing is a ring piston. Through a pressure medium connection provided in the housing, which issues into this intermediate space, it is possible to apply pressure to the ring piston and thus move it axially in the intermediate space, which at the same time forms a pressure chamber, whereby a bearing race of a throw-out bearing that is inserted into the end of the housing may also be displaced axially, whereby the diaphragm spring of the clutch can be operated. FIGS. 2a and 2b show a CSC with the individual rigidities defined by the corresponding construction elements of the throw-out bearing a1, the piston b1, the gasket c1, the thin-walled tube d1, the guide sleeve, the O-ring e1 and the interface to the transmission f1. FIG. 2a shows the CSC in sectional view and FIG. 2b in perspective view, from which the points of attachment can be recognized. The individual rigidities a1, b1 and f1 are not influenced by a change—specifically an enlargement—of the outer diameter of the cylinder chamber and thus of the piston diameter, and hence also not by the solution according to the invention. For this reason, the share of these individual rigidities in the overall loss of the system rigidity remains constant. If the outside diameter of the cylinder chamber is enlarged in proportion to the diameter of the piston area, the individual rigidity d1 is however reduced. The likewise associated reductions of the two individual rigidities c1 and e1 are added to that. According to experience, their share in the overall loss of the system rigidity is about 50%, and is proportional to the length of the seal.

From FIGS. 3a and 3b one sees a master cylinder 4 with the specific individual rigidities of the piston a2, the piston rod b2, the thin-walled tube c2, the guide sleeve, the gasket e2 and the interface to the pedal support or to the transmission d2 where FIG. 3a is a sectional view and FIG. 3b is a perspective depiction of master cylinder 4. The piston with the individual rigidity a2 is guided in a thin-walled tube with the individual rigidity c2. The seal with the individual rigidity e2 seals the pressure chamber from a return tank. At the attachment points which have the individual rigidities d2, master cylinder 4 is connected to a pedal support. The individual losses that occur at locations b2 through d2 are not changed when the piston diameter is changed, and are therefore not included in the solution according to the invention. Their contribution to the overall loss of the system therefore remains constant.

The same statement applies to the individual rigidity c2 as to the individual rigidity d1 in the case of the CSC. The individual rigidity e2 is proportional to the length of the seal, and thus, given the same seal geometry, is proportional to the diameter of the respective cylinder, since the same individual loss positions also apply to a slave cylinder 5.

In this view, the overall rigidity of master cylinder 4 and of slave cylinder 5 were assumed to be proportional to the cylinder diameter.

The following formulas describe the rigidity of the individual cylinders (master and slave cylinder) in the hydraulic path, starting from a base rigidity, from which the influence of the choice of diameter for the particular cylinder and thus also for the piston becomes clearly visible.

For a slave cylinder arranged concentrically around the transmission input shaft, the result is:

$$C ( Da ) = {C}_{0} \cdot \frac{{Da}_{0}}{Da}$$

The rigidity of the master and slave cylinders is calculated as follows:

$$C ( Da ) = \frac{{C}_{0}}{2} \cdot ( 1 + \frac{{Da}_{0} + {Di}_{0}}{Da + {Di}_{0}} )$$

where

C₀=base rigidity, defined as the rigidity of the hydraulic system according to the existing art

Da=outer diameter

Da₀=outer diameter of the existing art

Di=inner diameter

Di₀=inner diameter of the existing art

It is evident from these statements that as the outer diameter becomes larger the individual rigidity decreases. That would mean that the overall rigidity of the system also decreases. This is not the case, however; on the contrary, the overall rigidity of the system is increased by enlarging the piston diameter, since, assuming the same force conditions, the surface pressure is reduced by this design measure and as a result the system as a whole becomes more rigid. The rigidities of lines 11 and 12 are not taken into account in this consideration.

An additional way of looking at the situation is that the individual rigidity of a part influences the connection between the volume accommodated and the pressure, which is ultimately manifested in the loss path at this location for the disengagement system. The volume accommodated by the master and slave cylinders is influenced very significantly by the dynamic seal employed in them, among other factors. For example, in the case of a CSC a free space remains between this dynamic seal and the cylinder wall. This free space together with the seal length forms a volume. If pressure is applied to the cylinder, this free space is first filled by the seal. The volume of pressure medium displaced in the process constitutes a travel loss of the master cylinder. The seal itself can be regarded as nearly incompressible. A proportional connection is seen between the volume accommodated and the seal length. Consequently, an enlargement of the piston areas results in an enlargement of the volume accommodated. In addition, the rigidity of the master and slave cylinders is initially reduced and the volume accommodated is increased thereby. The input variable for the total system is not however the pressure, but the force to disengage the clutch. The pressure in the system thus drops when the piston areas are enlarged. But if we consider not the volume accommodated over the system pressure, but the loss path at the clutch pedal over the disengaging force, the enlargement of the piston areas results in a reduction of the loss path at the clutch pedal compared to the existing art.

FIGS. 4 through 9 clarify this reduction of the loss path for a disengagement system through the use of cylinders with enlarged piston areas.

From FIG. 4 we can see examples of the individual losses at a CSC, the lines 11, 12 and a master cylinder 4 according to the existing art.

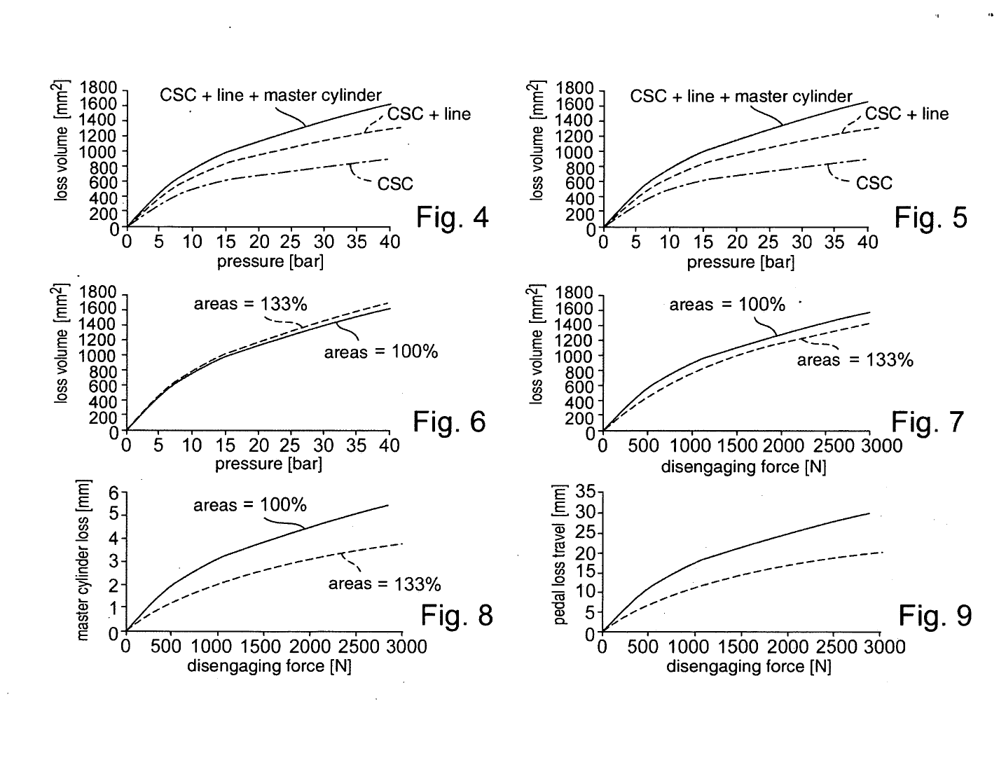

FIG. 5 shows the individual losses for a disengagement system of the same construction type with piston areas enlarged for example by 33%; that is, the hydraulic transmission ratio remains constant.

From FIG. 6 it is possible to see the total losses of the system with enlarged piston areas compared to those of the base system according to the existing art. This makes it clear that the pressure-related losses have also become greater through enlarging the piston area.

From the comparison (see FIG. 7) of the losses based on the system according to the existing art and of the system with the enlarged piston areas, referenced to the disengaging force, it is evident that it was possible to reduce the losses by enlarging the area.

The significant advantage of this solution according to the invention becomes clear however in a depiction based on master cylinder travel (see FIG. 8) or pedal travel (see FIG. 9). In the example shown here, the loss reduction from the disengagement system side is 30%, where in a first approximation a proportional connection between rigidity and enlargement of the piston areas is recognizable. With a disengaging force of 2000 N, for example, the disengaging reserve is increased as a result by around 8 mm. This advantage can also be used to reduce the force by increasing the transmission ratio of the disengagement system. A reduction of the pedal force by around 7% to 8% is possible for the example shown here.

### REFERENCE NUMBERS

1 hydraulic system
2 pressure limiting valve
3 clutch disengaging device
4 master cylinder
5 slave cylinder
6 disengaging mechanism
7 clutch
8 combustion engine
9 crankshaft
10 transmission input shaft
11 line run
12 line run
13 mechanical transmission
14 activating element
   the specific individual rigidities at the slave cylinder:
   a1 throw-out bearing
   b1 piston with sealing ring holder
   c1 gasket
   d1 thin-walled tube
   e1 O-ring
   f1 interface to the transmission
   the specific individual rigidities at the master cylinder:
   a2 piston
   b2 piston rod
   c2 thin-walled tube
   d2 interface to the pedal support or to the transmission
   e2 gasket

What is claimed is:

1. A hydraulic system comprising:
a master cylinder including a master cylinder housing, a pressure medium outlet and a master cylinder piston axially displaceable in the master cylinder, sealed against the master cylinder housing, and having a master cylinder piston specific individual rigidity;
a ring-shaped slave cylinder arranged concentrically around a transmission input shaft, and including a slave cylinder housing and a ring piston axially displaceable in the slave cylinder and sealed against the slave cylinder housing, the ring piston having a specific individual rigidity, the slave cylinder including a pressure medium inlet; and
a pressure medium line connecting the pressure medium inlet and the pressure medium outlet hydraulically, the master cylinder piston having an area of 300 mm²-1000 mm² and the ring piston for the slave cylinder having an area of 800 mm²-2500 mm² to increase a total rigidity of the hydraulic system.

2. The hydraulic system as recited in claim 1 wherein the master cylinder piston has an area of 350 mm²-500 mm² and the ring piston has an area of 1000 mm²-1500 mm².

3. The hydraulic system as recited in claim 1 wherein a proportional connection exists between the total rigidity and the enlargement of the piston areas.

4. The hydraulic system as recited in claim 1 wherein the hydraulic system is for motor vehicles.

5. A method for increasing a base rigidity by providing the hydraulic system as recited in claim 1 comprising the steps of:
increasing a previous master piston area so that the master cylinder piston has the area of 300 mm²-1000 mm²; and
increasing a previous ring piston area so that the ring piston for the slave cylinder has the area of 800 mm²-2500 mm².

6. A hydraulic system comprising:
a master cylinder including a master cylinder housing, a pressure medium outlet, and a master cylinder piston axially displaceable in the master cylinder and sealed against the master cylinder housing;
a ring-shaped slave cylinder arranged concentrically around a transmission input shaft, and including a slave cylinder housing and a ring piston axially displaceable in the slave cylinder and sealed against the slave cylinder housing, the slave cylinder including a pressure medium inlet;
a pressure medium line connecting the pressure medium inlet and the pressure medium outlet hydraulically, a force introduced by an actuator for disengaging a clutch being transmitted via the pressure medium line, the master cylinder piston having an area of 300 mm²-1000 mm², and the ring piston having an area of 800 mm²-2500 mm² to reduce the disengaging force.

7. The hydraulic system as recited in claim 6 wherein a clutch disengaging reserve increases through the enlargement of the piston areas.

8. The hydraulic system as recited in claim 6 wherein the hydraulic system is for motor vehicles.

9. The hydraulic system as recited in claim 6 wherein the master cylinder area is 350 mm²-500 mm².

10. The hydraulic system as recited in claim 6 wherein the slave cylinder area is 1000 mm²-1500 mm².

11. A method for decreasing a disengaging force by providing the hydraulic system as recited in claim 6 comprising the steps of:
increasing a previous master piston area so that the master cylinder piston has the area of 300 mm²-1000 mm²; and
increasing a previous ring piston area so that the ring piston for the slave cylinder has the area of 800 mm²-2500 mm².

12. The hydraulic system as recited in claim 6 wherein the actuator is a pedal.

13. The hydraulic system as recited in claim 12 wherein a pedal force for disengaging the clutch is reduced at least 7 percent.

14. The hydraulic system as recited in claim 13 wherein the pedal force is reduced by 8%.
